(19) United States
(12) Patent Application Publication
(10) Pub. No.: US 2006/0140132 A1
(43) Pub. Date: Jun. 29, 2006

(54) Apparatus and method for performance management in MPLS network

(76) Inventors: Ki-Cheol Lee, Sungnam-si (KR); Kee-Sung Nam, Seoul (KR)

Correspondence Address: Robert E. Bushnell, Suite 300, 1522 K Street, N.W., Washington, DC, 20005-1202, US

(21) Appl. No.: 11/313,794

(22) Filed: Dec. 22, 2005

(30) Foreign Application Priority Data
Dec. 23, 2004 (KR) 10-2004-0111399

(51) Int. Cl. H04J 1/16; H04L 12/56; H04J 3/14

(52) U.S. Cl. 370/248; 370/216; 370/389

(57) ABSTRACT

In an apparatus for a performance management of a label switching path (LSP) set in a multi protocol label switching (MPLS) network and a method thereof, a determination is made as to whether the LSP satisfies a required performance criterion in the network, and protection of the LSP or replacement of the LSP not satisfying the required performance with a substitute LSP is carried out.

### CLAIM OF PRIORITY

This application makes reference to, incorporates the same herein, and claims all benefits accruing under 35 U.S.C. § 119 from an application for APPARATUS AND METHOD FOR PERFORMANCE MANAGEMENT IN MPLS NETWORK earlier filed in the Korean Intellectual Property Office on 23 Dec. 2004 and there duly assigned Serial No. 10-2004-0111399.

### BACKGROUND OF THE INVENTION

1. Field of the Invention

The present invention relates to an apparatus and a method for performance management in a multi protocol label switching (MPLS) network, and more particularly, to an apparatus and a method for performance management in an label switching path (LSP) of an MPLS network.

2. Related Art

At present, various multimedia services requiring guarantee of quality of service (QoS), such as Voice over Internet Protocol (VoIP), video phone, video conference, IP TV, Video on Demand (VoD) and so on have been provided through a network. In order to provide these services requiring guarantee of QoS, technologies such as DiffServ, 802.1p, MPLS, and so on have been developed. Among them, the MPLS can be adapted to an IP network, to an asynchronous transfer mode (ATM) network, and so on, so as to guarantee the QoS of the network.

The data transfer path of the IP/MPLS or ATM/MPLS network is defined as an label switching path (LSP). In order to guarantee of QoS, performance management of the LSP is essentially required in the processes of not only LSP setting but also LSP operation. The performance of LSP can be analyzed by various items, characteristics or factors, such as delay, jitter, packet loss, and so on. To this end, an MPLS operation, administration & maintenance (OAM) mechanism is required.

However, the performance management method of the MPLS network according to known technologies focuses on the connectivity check of the LSP rather than the performance check of the LSP. Moreover, up to the present, there has been no suggestion for an apparatus and a method for performance management of an MPLS network providing a concrete way for achieving LSP performance analysis and management. That is, an apparatus and a method for performance management of an MPLS network using the results of LSP performance analysis for LSP performance management in the MPLS network have not been developed.

### SUMMARY OF THE INVENTION

It is, therefore, an object of the present invention to provide an apparatus and a method for performance management of an MPLS network in which LSP performance is measured and analyzed so as to enable the management of LSP performance in accordance with the analyzed result of performance.

It is another object of the present invention to provide an apparatus and a method for performance management of an MPLS network capable of displaying the quality of an LSP depending upon the analyzed result of LSP performance.

It is still another object of the present invention to provide an apparatus and a method for performance management of an MPLS network capable of conducting protection/restoration for a degraded LSP depending upon the analyzed result of LSP performance.

To achieve the above and other objects, there is provided an apparatus and method for performance management of a multi protocol label switching (MPLS) network, in which apparatus and method traffic transfer is conducted through a preset label switching path (LSP).

Preferably, the apparatus of the invention comprises: an LSP monitoring section which receives a performance measurement value of an LSP from a respective MPLS edge switch (MES), compares the performance measurement value with a threshold so as to output an analysis value, and determines the protection of a corresponding LSP if the outputted value satisfies a certain condition; and an LSP computation section which, if it receives a request for protection of the LSP from the LSP monitoring section, determines whether an LSP for replacing the LSP exists so that, if the replacing LSP exists, the LSP is replaced with the replacing LSP, and if not, an LSP replacing the LSP is set and the LSP is switched into the set replacing the LSP.

According to another aspect of the present invention, a method for performance management of multi protocol label switching (MPLS) network, in which traffic transfer is conducted through a preset label switching path (LSP), comprises the steps of: measuring a performance value of the LSP; outputting an analysis value by comparing the measured value of the LSP with a threshold; determining whether the analysis value satisfies a certain condition; and determining protection of the LSP when the analysis value satisfies the condition.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram illustrating performance management of a multi protocol label switching (MPLS) network using an MPLS ping/traceroute;

FIG. 2 is a block diagram of an MPLS network in which the present invention can be employed;

FIG. 3 is a block diagram of a performance management apparatus of an MPLS network according to the present invention;

FIG. 4 is a diagram illustrating the measurement of performance values used for monitoring the performance of a label switching path (LSP) by use of an operation, administration & maintenance (OAM) packet;

FIGS. 5A and 5B are diagrams illustrating the embodiments of the performance threshold setting used for the performance management of an MPLS network according to the present invention;

FIG. 6 is a flow chart illustrating the case wherein a performance analyzing device sets two levels of performance threshold, thereby conducting a performance analysis of an LSP according to an embodiment of the present invention;

FIG. 7 is a flow chart illustrating the case wherein a performance analyzing device sets a single level of performance threshold, thereby conducting a performance analysis of an LSP according to another embodiment of the present invention;

FIG. 8 is a flow chart illustrating the case wherein an MES sets two levels of performance threshold, thereby conducting a performance analysis of an LSP according to yet another embodiment of the present invention;

FIG. 9 is a flow chart illustrating the case wherein an MES sets a single level of performance threshold, thereby conducting a performance analysis of an LSP according to still yet another embodiment of the present invention;

FIG. 10 is a flow chart illustrating an algorithm for performance management of an LSP when the performance threshold is set in two levels according to still another embodiment of the present invention; and

FIG. 11 is a flow chart illustrating an algorithm for performance management of an LSP when the performance threshold is set in a single level according to still another embodiment of the present invention.

### DETAILED DESCRIPTION OF THE INVENTION

Hereinafter, the preferred embodiments of the present invention will be described in detail with reference to the drawings attached. In the description, if the detailed explanation of related known functions or constructions is determined to unnecessarily render the gist of the present invention ambiguous, the detailed explanation will be omitted.

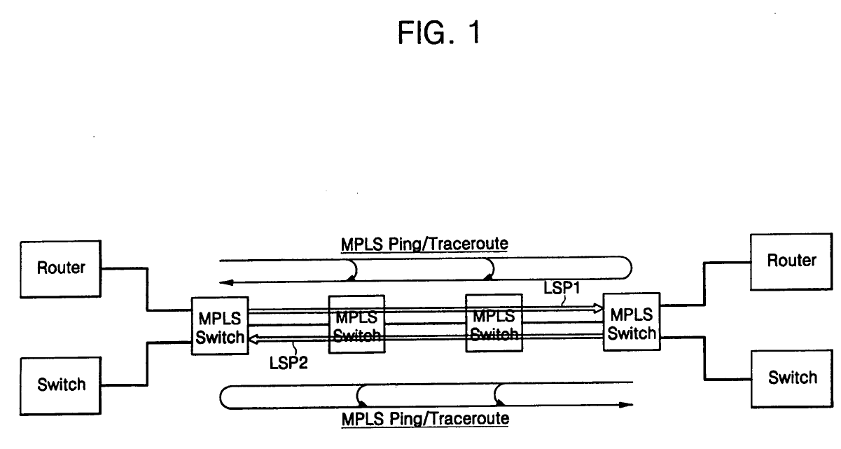

FIG. 1 is a block diagram illustrating performance management of an MPLS network using an MPLS ping/traceroute.

The method of MPLS ping (packet internet groper)/traceroute, as illustrated in FIG. 1, is a method in which an MPLS ping message is transferred from an LSP source node to an LSP destination node and, depending upon the completion of transfer, a determination is made as to whether the LSP is operating normally. In this case, an MPLS traceroute message is used to check the position of failure generation if a problem occurs in the LSP. Through the method of MPLS ping, as illustrated in FIG. 1, the round-trip delay and the round-trip packet loss of the LSP can be obtained. In addition, a standardized MPLS OAM technology for connectivity check of the MPLS LSP in ITU-T Y.1711 is provided.

The present invention as described below monitors the case wherein the performance of the LSP is seriously degraded, or an LSP failure is generated in the MPLS network, and can conduct a restoration function such that an unusable LSP is removed and a new LSP is computed, or otherwise the unusable LSP is replaced by a substitute LSP.

The present invention as described below measures the performance of an LSP set in the MPLS network, analyzes the measurement result, and manages the network using the analyzed result. The term “performance management”, as used in this specification, means only control of the MPLS network according to the analysis result, differently from “performance management” appearing in the title of the invention. However, the present invention encompasses not only “performance management” as described below in the narrow sense, but also “performance management” in a broader sense, including performance measurement and analysis of the LSP.

First, a network in which the present invention can be employed will be explained with reference to the attached drawings.

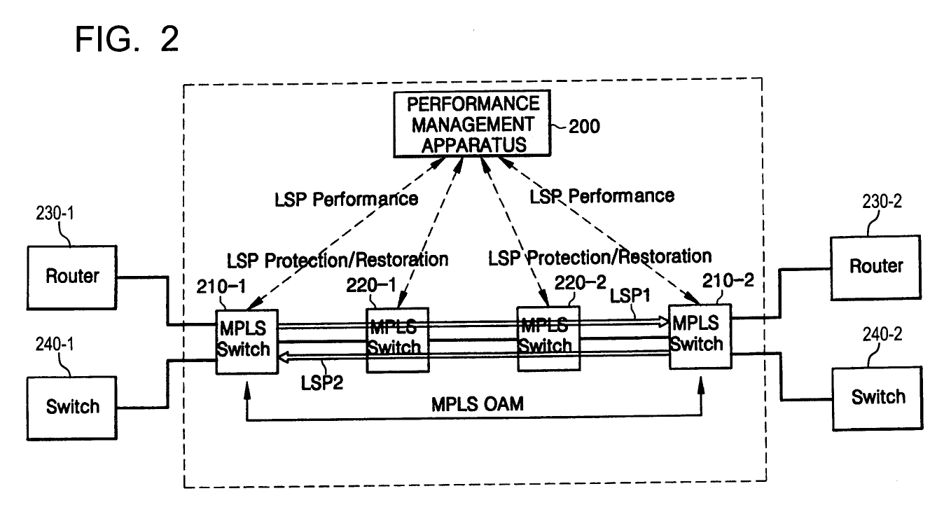

FIG. 2 is a diagram of an MPLS network in which the present invention can be employed.

As illustrated in FIG. 2, the MPLS network in which the present invention can be employed includes: a performance management apparatus 200 for managing the performance of an LSP of the MPLS network: an MES (MPLS Edge Switch) 210-1 or 210-2 for mapping data, such as an IP packet and so on, inputted to the LSP in the MPLS network, or for transferring the MPLS packets from an MPLS core switch (MCS) 220-1 or 220-2 to a router 230-1 or 230-2, or to a switch 240-1 or 240-2, wherein the MCS 220-1 or 220-2 switches the MPLS packets. The MES 210-1 or 210-2 is positioned at an edge of the network so as to map the inputted data to the LSP, while the MCS 2201- or 220-2 is positioned inside the MES 210-1 or 210-2 so as to switch the transferred MPLS packets. The LSP may be set between one MES 210-1 or 210-2 and the other MES 210-1 or 210-2. The MES 210-1 or 210-2 can measure the performance of the set LSP. The MES 210-1 or 210-2 transmits the measured performance value of the LSP, or otherwise analyzes the measured performance value of the LSP to thus transmit an analysis result value to the performance management apparatus 200. The performance management apparatus 200 receives the LSP performance measurement value from the MES 210-1 or 210-2 so as to analyze it, and according to the analysis result, it can conduct performance management for the MPLS network. Otherwise, the apparatus receives the LSP performance analysis value from the MES 210-1 or 210-2, and according to the received analysis value, it conducts a performance management for the MPLS network.

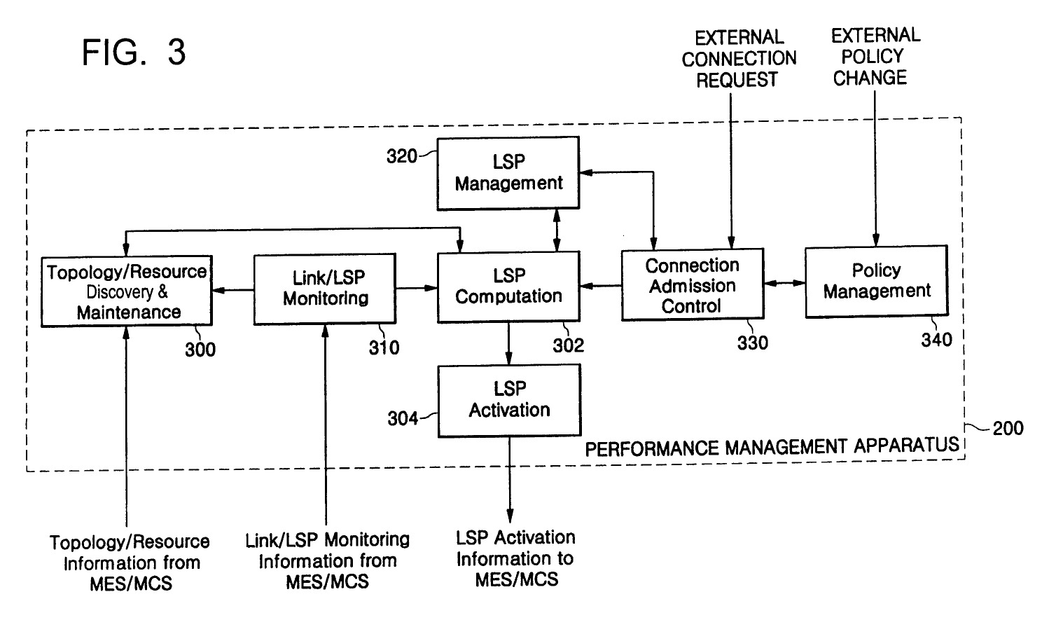

FIG. 3 is a block diagram of a performance management apparatus of an MPLS network according to the present invention.

The performance management apparatus 200 of the present invention may be configured so as to include a topology/resource connecting section or topology/resource discovery & maintenance section 300, an LSP computation section 302, an LSP activation section 304, a link/LSP monitoring section 310, an LSP management section 320, a connection admission control section 330, and a policy management section 340.

Herein, the topology/resource discovery maintenance section 300 collects topology information and resource information relating to a centralized control type of MPLS network according to the present invention. The LSP computation section 302 conducts LSP computation using collected topology/resource information. The LSP activation section 304 conducts an LSP activation process for transmitting LSP information set in the respective MPLS switches.

The link/LSP monitoring section 310 manages a link of the MPLS network, and performance and failure of the LSP set therein. The LSP management section 320 stores information on the computed and set LSP, and manages the operation of MPLS network. The connection admission control section 330 is connected to an external object, such as an external operator or external call server (for example, a soft switch), and so on, and when it receives a connection request for service from the external object, it determines whether the LSP and resource usable for the service request exists with reference to the LSP management section 320. As a result, it determines whether the connection request for service is admitted.

The policy management section 340 receives a policy for LSP setting and management of the MPLS network from the operator 360, and enables the policy to be reflected in the operation of the LSP computation section 302, the LSP monitoring section 310, the LSP management section 320, or the connection admission control section 330, and so on.

Among the constitutional elements, those especially concerned with the present invention are the LSP monitoring section 310 which receives LSP performance measured or analyzed by the respective MES 210-1 or 210-2 so as to thus conduct a performance management algorithm of the LSP according to the present invention, the LSP computation section 302 and LSP activation section 304 which conduct protection or restoration of the LSP if the performance of the LSP is seriously degraded or recovered again, the LSP management section 320 which manages the status of the LSP, and so on. In addition, the policy management section 340 may be used for policy determination of LSP performance management.

Hereinafter, the LSP performance management conducted by the performance management apparatus of the present invention will be described in detail. The process of the present invention may be generally divided into LSP performance measurement, analysis for measured performance, and performance management according to the analyzed result.

Among the latter functions or processes, LSP performance measurement is conducted at MES 210-1 or 210-2. The respective MES 210-1 or 210-2 measures performance values of various items, such as delay, jitter, packet loss and so on, for the respective LSPs set. The LSP performance measurement of the MPLS network can be conducted by use of an OAM packet.

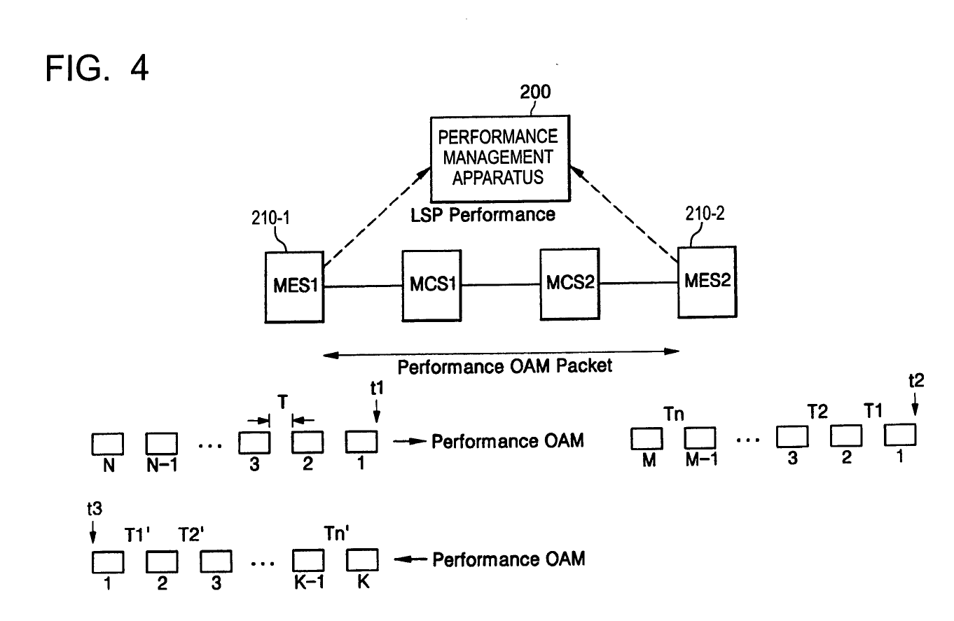

FIG. 4 is a diagram illustrating the measurement of performance values used for monitoring the performance of an LSP by use of an OAM packet.

Through transfer of an OAM packet, values of transfer delay, jitter, transfer loss, and so on in the LSP may be measured. In FIG. 4, one-way transfer delay is the time required for transfer of an OAM packet between MES1 and MES2, i.e., “t2-t1”, one-way jitter is a dispersion value of T1 to Tn, i.e., “var{T1, T2, . . . , Tn}”, and one-way transfer loss is a ratio of the quantity of received packets at the receiver side to that of transmitted packets at the transmitter side, i.e., “M/N”. Moreover, round-trip transfer delay is a time until response packet is received in response to transmit packet, i.e., “t3-t1” in FIG. 4. The round-trip jitter becomes “var{T1′, T2′, . . . , Tn′}”, and the round-trip transfer loss becomes “K/N”.

The LSP performance value measured in this way should be analyzed depending on a certain reference, and such analysis can be conducted at MES 210-1 or 210-2, or otherwise at the link/LSP monitoring section 310 of the performance management apparatus 200. The analysis of the measured LSP performance value can be conducted according to the same reference irrespective of whether it is conducted or not conducted at the MES 210-1 or 210-2, or at the performance management apparatus 200, so that the reference usable for analysis of performance value will be now described.

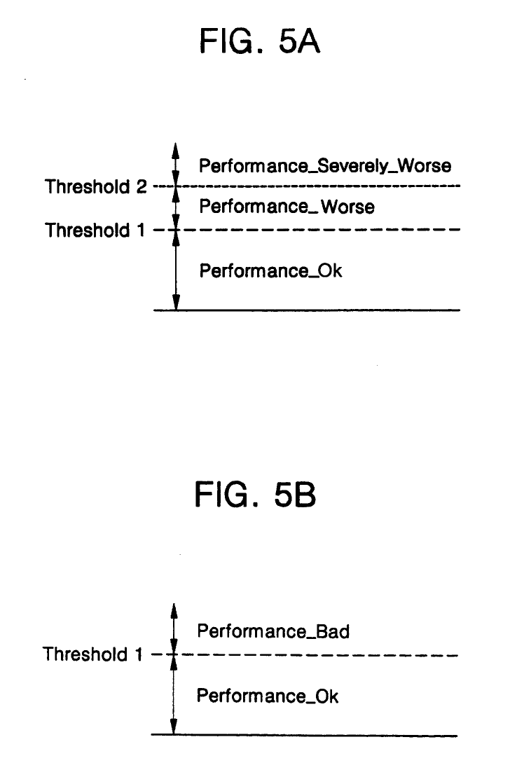

FIGS. 5A and 5B are diagrams illustrating the embodiments of the performance threshold setting used for the performance management of an MPLS network according to the present invention.

FIG. 5A illustrates an LSP performance analysis which specifically uses two performance thresholds as a reference value for LSP performance analysis. Of these thresholds, a preferable one is selected according to the characteristic of network. These thresholds may be stored in the policy management section 340. The LSP performance value measured at the MES 210-1 or 210-2 is compared to the respective thresholds, threshold 1 and threshold 2, which are illustrated in FIG. 5A, to thus determine what the value has an analysis value. Herein, threshold 1 is less than threshold 2. Moreover, FIG. 5A illustrates having a value of “performance_OK” if the measured LSP performance value is less than threshold 1. This means that the lesser the measured LSP performance value is, the more excellent the performance is. This is because, in the case of FIG. 5A, it is assumed that it takes items that are estimated to have a more excellent performance as the LSP performance value is lesser. For example, in the case of transfer delay, jitter, packet loss, and so on, such items are estimated to have more excellent performance as the measured value is lesser. Of course, in contrast to FIG. 5A, the items that are estimated to have a more excellent performance as the measured value is larger should be given an analysis value of “performance_OK” for a measured value larger than threshold 2. The LSP performance analysis should be conducted for all of the items that one tends to consider.

If the measured LSP performance value is lesser than threshold 1, the analysis value for the performance value becomes “performance_OK”. If the measured LSP performance value is larger than threshold 1 but less than threshold 2, the analysis value for the performance value becomes “performance_worse”. If the measured LSP performance value is larger than threshold 2, the analysis value for the performance value becomes “performance_severely_worse”. Of course, the present invention is not limited to the abovementioned terms, and if operated in the same manner as such, they shall be included in the present invention, even using other terms.

The LSP performance analysis will be now described with reference to a specific embodiment.

For example, analysis is conducted assuming that, in the case of “transfer delay”, threshold 1 is 20 ms and threshold 2 is 30 ms. Under this condition, if 25 ms of transfer delay is measured for a certain LSP, that LSP may have the performance analysis value of performance_worse for the transfer delay item.

Meanwhile, the performance analysis explained above was conducted for only a single item, such as transfer delay, jitter or packet loss, and so on, of the respective LSP. The analysis of the whole performance of the LSP, as opposed to analysis for the respective item, can be conducted as follows.

If the measured performance values for all items are more excellent than threshold 1, a result of performance_OK is generated. If any one of the measured performance values deviates from threshold 2, a result of performance_severely_worse is generated. If any one of the measured performance values deviates from threshold 1 but is within threshold 2, a result of performance_worse is generated.

FIG. 5B illustrates an LSP performance analysis which specifically uses a single performance threshold as a reference value for LSP performance analysis. The illustration of FIG. 5B is similar to FIG. 5A. The only differences are that, in FIG. 5B, a single threshold is provided, and the measured LSP performance value is compared with threshold 1, with the result that if it is larger than threshold 1, the performance analysis value becomes “performance_bad”, and if it is lesser than or the same as threshold 1, the performance analysis value becomes “performance_good”.

Herein, in consideration of all of the items of LSP as opposed to respective items, if the measured performance values for all of the items are greater than the threshold, a result of performance_OK can be generated, and if any one of the measured values deviates from threshold, a result of performance_bad can be generated.

As explained above, the LSP performance analysis may be conducted at MES 210-1 or 210-2, or otherwise at the LSP monitoring section 310 of the performance management apparatus 200.

Hereinafter, two type of embodiments for LSP performance analysis will be described. The first embodiments are concerned with performance analysis by the performance analysis apparatus 200 through comparison with two levels of thresholds or a single level of threshold, and the second embodiments are concerned with performance analysis by MES 210-1 or 210-2 through comparison with two levels of thresholds or a single level of threshold.

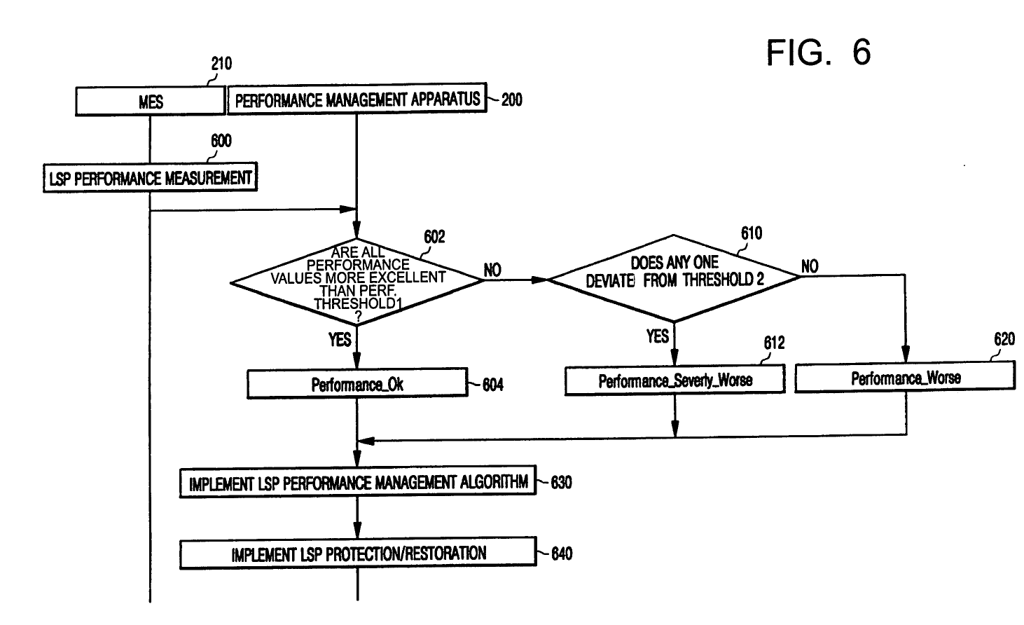

FIG. 6 is a flow chart illustrating the case wherein a performance analysis apparatus sets two levels of performance threshold, thereby conducting a performance analysis of an LSP according to an embodiment of the present invention.

In the case wherein the performance management apparatus 200 conducts the LSP performance analysis, the MES 210-1 or 210-2 conducts only the measurement of the LSP performance value. In step 600 of FIG. 6, the MES 210-1 or 210-2 measuring the LSP performance value transmits the measured performance value to the performance management apparatus 200.

Once the LSP performance value is received, the performance management apparatus 200 conducts a performance analysis by comparison of the received LSP performance value with two thresholds. These steps correspond to steps 602 to 630.

At step 602, the performance management apparatus 200 performs the comparison “Are performance values more excellent than performance threshold 1?’. If the comparison result indicates that all of the values have more excellent performance than threshold 1, the performance management apparatus 200 generates, at step 604, a result of “Performance_OK”. If not, it determines, at step 610, whether any one of the measured performance values deviates from threshold 2. If the result at step 610 indicates that one of the measured performance values deviates from threshold 2, the performance management apparatus 200 generates, at step 612, a result of “Performance_Severely_Worse”. If not, it generates, at step 620, a result of “Performance_Worse”.

The performance management apparatus 200, upon completing performance analysis at step 604, implements an algorithm for LSP performance management performance analysis, and then implements LSP protection/restoration at step 640. The LSP performance management algorithm at step 630 can be implemented at the LSP monitoring section 310 of the performance management apparatus 200. The LSP performance management algorithm will be explained again later.

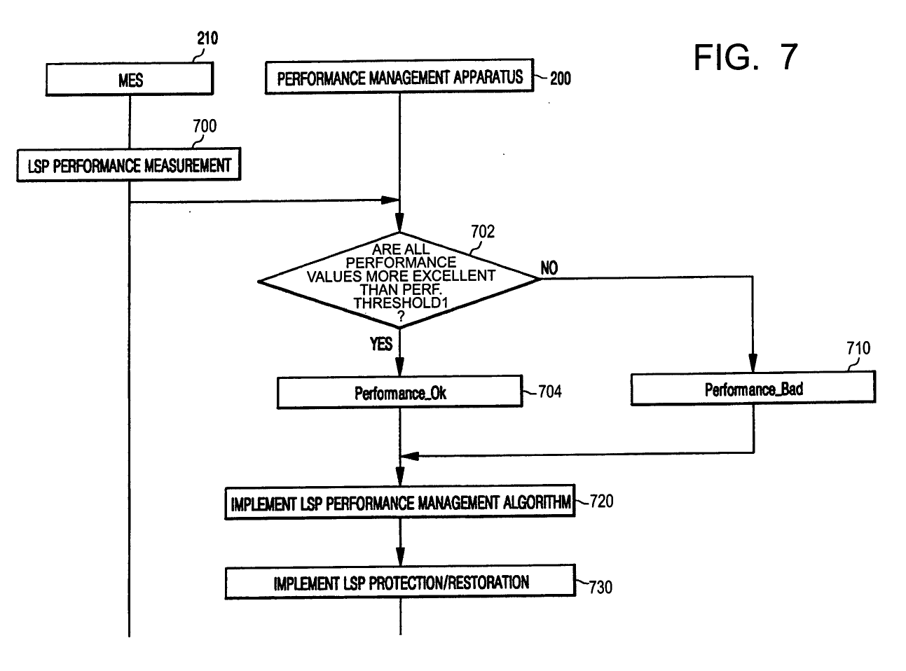

FIG. 7 is a flow chart illustrating the case wherein a performance analysis apparatus sets a single level of performance threshold, thereby conducting a performance analysis of an LSP according to another embodiment of the present invention.

The steps illustrated in FIG. 7 are similar to those of FIG. 6. However, for FIG. 7, upon conduct of the performance analysis of LSP, the measured value of LSP is compared to one threshold.

At step 700 in FIG. 7, LSP performance measurement commences. At the step 702, the performance management apparatus 200 determines whether all of the performance values have more excellent performance than threshold 1. If the result indicates that all of the values have more excellent performance than threshold 1, the performance management apparatus 200 generates, at step 704, a result of “Performance_OK”. If not, it generates at step 710 a result of ‘performance_Bad’. The generated comparison results, i.e., analysis values, are transmitted to the LSP monitoring section 310, and are used as a basis for implementing the LSP performance management algorithm (step 720), as a result of which LSP protection/restoration is implemented (step 730).

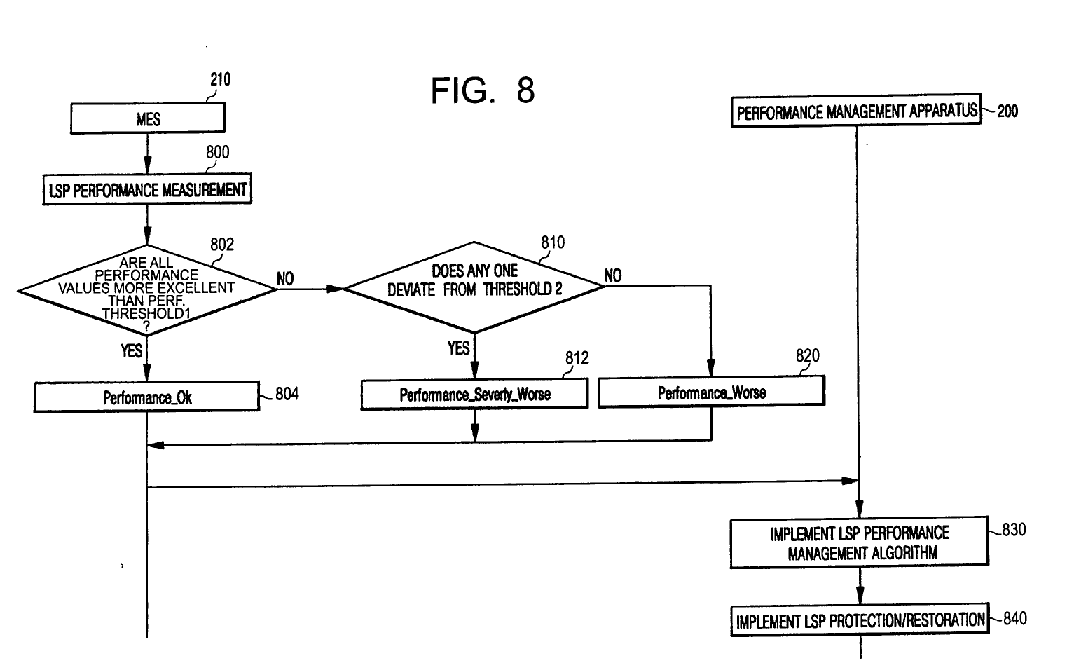

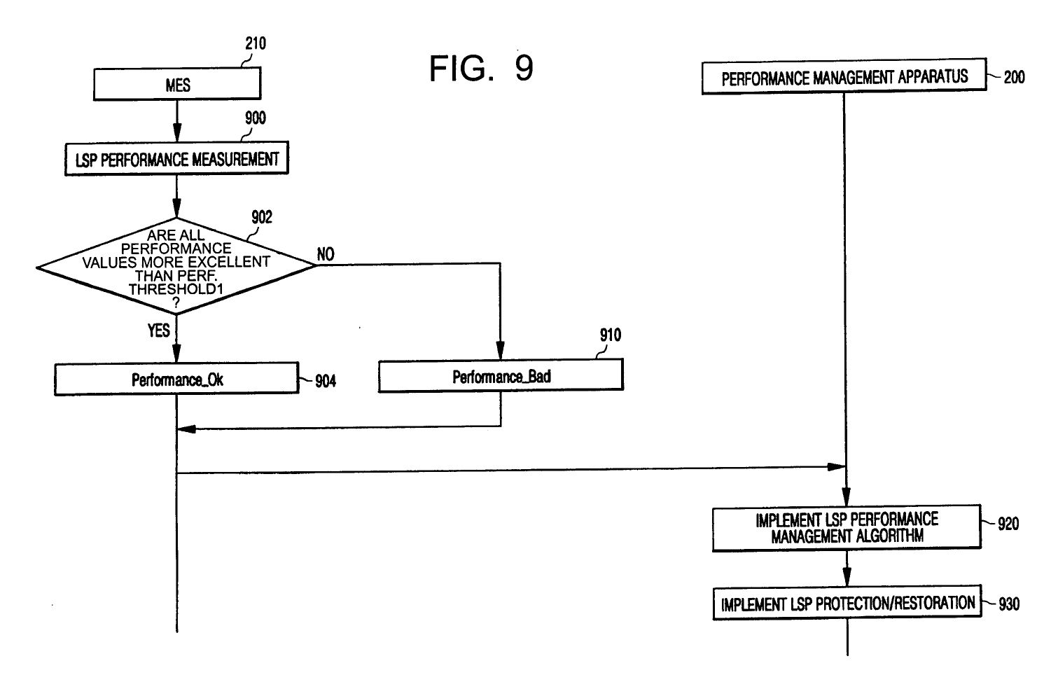

FIG. 8 is a flowchart illustrating the case wherein an MES sets two levels of performance threshold, thereby conducting a performance analysis of an LSP according to another embodiment of the invention, and FIG. 9 is a flowchart illustrating the case wherein the MES sets a single level of performance threshold, thereby conducting a performance analysis of an LSP according to still yet another embodiment of the invention.

FIGS. 8 and 9 are similar to FIGS. 6 and 7 with the exception that the LSP performance analysis by comparison of the measured value of LSP with the threshold is conducted at MES 210-1 or 210-2 rather than the performance management apparatus 200. The explanation on FIGS. 8 and 9 will be omitted.

Of course, in setting of the threshold, in addition to one or two levels of threshold, other levels of thresholds may be set according to the requirement of the network.

The compared result values, i.e., the LSP performance analysis values, as illustrated in FIGS. 6 thru 9, are used for carrying out the LSP performance management algorithm in the LSP monitoring section 310. A representative example of the LSP performance management algorithm involves a determination as to whether the performance of LSPs satisfies QoS requirements. As a result of conducting the LSP performance algorithm, if the LSP does not satisfy the required performance, the countermeasure of transferring data through a substitute LSP may be carried out.

If the LSP performance becomes severely degraded, the LSP monitoring section 310 implementing the LSP performance management algorithm outputs an LSP protection/restoration command to the LSP computation section 302. When the LSP protection/restoration command is received from the LSP monitoring section 310, the LSP computation section 302 outputs a command for switching the corresponding LSP to the LSP activation section 304 if there is a preset switching path. However, if there is not a preset switching path, the LSP computation section 302 computes an LSP restoration path, and outputs the computed restoration path to the LSP activation section 304. When the switching or restoration path is received from the LSP computation section 302, the LSP activation section 304 transmits the switching or restoration path to each MES 210-1 or 210-2.

Meanwhile, if the degraded LSP performance is recovered as a result of implementing the LSP performance management algorithm, the LSP monitoring section 310 outputs an LSP restoration command to the LSP computation section 302, and the LSP computation section 302 receiving the restoration command transmits a path restoration command to the MES 210-1 or 210-2 and the MCS 220-1 or 220-2 via the LSP activation section 304 so as to restore the path to its original LSP. The status of the LSP, protected (or switched) or restored through the above process, is outputted and managed at the LSP management section 320.

As described before, LSP protection/restoration implemented for the LSP in question may be conducted in such a way that, upon the generation of a problem in the original LSP, it is replaced by a substitute LSP and the data transfer is conducted with the substitute LSP. If the problem of the original LSP is later solved, data transfer is the conducted with the original LSP. Also, another way of providing LSP protection/restoration is that, upon the generation of a problem in the original LSP, the substitute LSP is used and, at the same time, the original LSP is prepared as a new substitute LSP for the LSP replacing the original LSP. Furthermore, if there are a plurality of available LSPs, there may be provided another process in which the performance management algorithms for the respective LSPs are executed, and at the same time, data transfer is conducted by way of the best performing LSP selected from all LSPs. Among these processes, the best process for a particular network may be used, and the selection of those processes may be conducted by the policy management section 340.

The above-mentioned processes of LSP performance analysis, the execution of the LSP performance management algorithm, and the LSP protection/restoration process will now be explained with reference to the drawings.

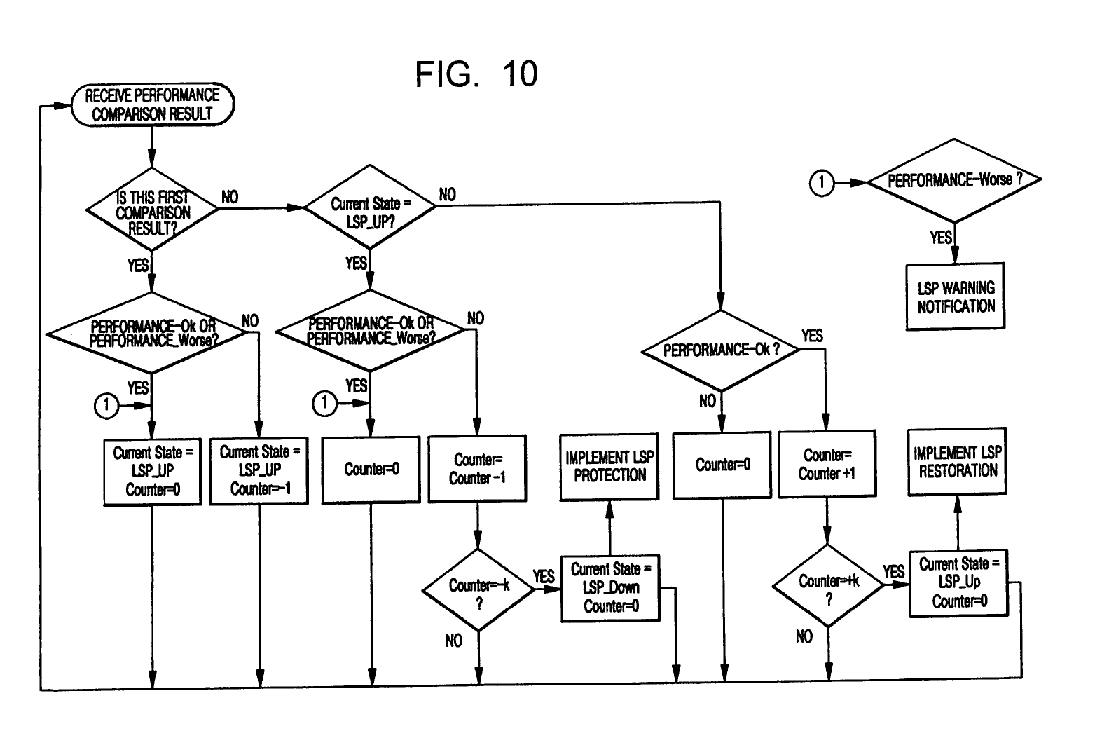

FIG. 10 is a flow chart illustrating an algorithm for performance management of an LSP when the performance threshold is set in two levels according to still another embodiment of the present invention.

The performance management algorithm of FIG. 10 is carried out based on assumptions as follows:

(1) if the comparison result of LSP performance indicates performance_severely_worse k times (i.e., if the LSP performance is estimated to be severely degraded k times), implementation of protection/restoration for the corresponding LSP take place, wherein k may be selected according to a characteristic of the network so that the present invention is not limited to a specific value of k;

(2) if the comparison result of LSP performance indicates performance_OK k times after the implementation of LSP protection/restoration (i.e., if the LSP performance is more excellent than threshold k times), implementation of the restoration of the corresponding LSP (i.e., restoration to the original LSP) takes place; and

(3) if the comparison result of LSP performance indicates performance_worse, an LSP warning signal is transferred to an operator.

Table 1 illustrates an embodiment of an LSP performance comparison table for the performance management algorithm of FIG. 10, provided that k=3.

TABLE 1

| | Ok | W | S. W | S. W | W | W | S. W | S. W | S. W | S. W | W | Ok | S. W | Ok | Ok | Ok | W | S. W |
|---|---|---|---|---|---|---|---|---|---|---|---|---|---|---|---|---|---|---|
| Counter | 0 | 0 | −1 | −2 | 0 | 0 | −1 | −2 | −3 | 0 | 0 | +1 | 0 | +1 | +2 | +3 | 0 | −1 |
| Current | Up | Up | Up | Up | Up | Up | Up | Up | Down | Down | Down | Down | Down | Down | Down | Up | Up | Up |
| state | | | | | | | | | | | | | | | | | | |
| LSP | | | | | | | | | protec- | | | | | | | restoration | | |
| man- | | | | | | | | | tion | | | | | | | | | |
| age- | | | | | | | | | | | | | | | | | | |
| ment | | | | | | | | | | | | | | | | | | |

In Table 1, “S.W” means Severely_Worse, and “W” means Worse.

The flow chart of FIG. 10 is briefly described as follows.

When received a performance analysis value is received, the performance management apparatus 200 of the present invention determines whether the received analysis value is performance_OK, peformance_worse, or performance_severely_worse. If the performance analysis value is performance_severely_worse, a counter value is set to −1. If the analysis value of performance_severely_worse is received again, the counter value is set to −2; otherwise, it is reset to 0. If the counter value reaches −k, making the current status of LSP down, a replacement LSP is substituted.

Meanwhile, when the analysis value of performance_OK is received under the down state of the current status of LSP, the counter is set to the value +1. If the next analysis value received is performance_OK, the counter is set to +2; otherwise, the counter value is reset to 0. If the counter value reaches +k, this indicates that, after the implementation of the LSP protection/restoration, the LSP performance is performance_OK k times, so that the LSP restoration is implemented. This is a process for recovering the LSP to its original LSP before the LSP protection/restoration took place by notifying the LSP computation section 302. If the LSP performance analysis value is performance_worse, an operator is notified of an LSP warning. The flow chart for the construction of the above algorithm may be illustrated in various ways in addition to that of FIG. 10.

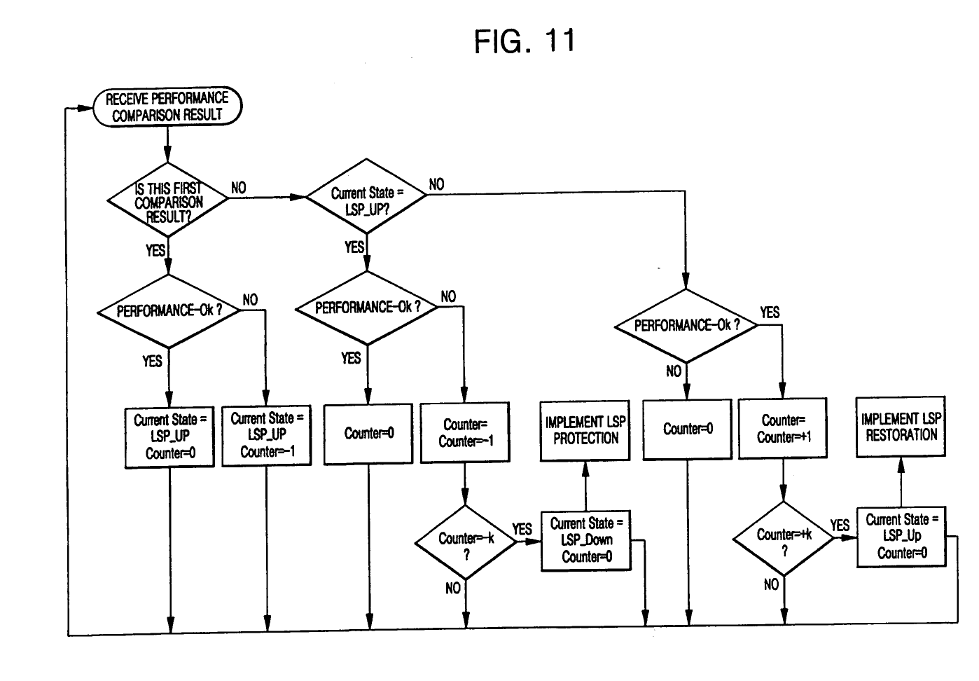

FIG. 11 is a flowchart illustrating an algorithm for performance management of an LSP when the performance threshold is set in a single level according to an embodiment of the present invention.

The performance management algorithm of FIG. 11 is carried out based on assumptions as follows:

(1) if the comparison result of LSP performance indicates performance_bad k times (i.e., if the LSP performance is estimated to be degraded k times), implementation of a protection/restoration for the corresponding LSP is carried out; and

(2) if the comparison result of LSP performance indicates performance_OK k times after the implementation of the LSP protection/restoration (i.e., if the LSP performance is more excellent than threshold k times), implementation of the restoration of the corresponding LSP takes place.

Table 2 illustrates an embodiment of an LSP performance comparison table for the performance management algorithm of FIG. 11, provided that k=3.

TABLE 2

| | Ok | Ok | Bad | Bad | Ok | Bad | Bad | Bad | Bad | Bad | Ok | Bad | Ok | Ok | Ok | Bad | Ok | Bad |
|---|---|---|---|---|---|---|---|---|---|---|---|---|---|---|---|---|---|---|
| Counter | 0 | 0 | −1 | −2 | 0 | −1 | −2 | −3 | 0 | 0 | +1 | 0 | +1 | +2 | +3 | −1 | 0 | −1 |
| Current | Up | Up | Up | Up | Up | Up | Up | Down | Down | Down | Down | Down | Down | Down | Up | Up | Up | Up |
| state | | | | | | | | | | | | | | | | | | |
| LSP | | | | | | | | protec- | | | | | | | restoration | | | |
| man- | | | | | | | | | | | | | | | | | | |
| age- | | | | | | | | | | | | | | | | | | |
| ment | | | | | | | | | | | | | | | | | | |

The LSP performance management algorithm of FIG. 11 is the same as that of FIG. 10, with the exception that there is not a value of performance_worse. Since the performance management algorithm of FIG. 11 has a single level of performance threshold, there is only a determination as to whether it is evaluated performance_OK. The flow chart for the construction of the above algorithm may be illustrated in various ways in addition to that of FIG. 11.

Meanwhile, the present invention can be adapted in the same way to the LSP performance measurement and the link performance measurement relative to the MPLS network. However, the collection of the link information as such may be measured by the MCS together with the MES.

The present invention can be effectively used for LSP management in the MPLS network, essentially requiring the guarantee of QoS, thereby providing high quality of multimedia services to users by use of the LSP management method of the present invention, while guaranteeing LSP performance.

While the invention has been described in conjunction with various embodiments, they are illustrative only. Accordingly, many alternatives, modifications and variations will be apparent to persons skilled in the art in light of the foregoing detailed description. The foregoing description is intended to embrace all such alternatives and variations falling with the spirit and broad scope of the appended claims.

What is claimed is:

1. An apparatus for performance management of a multi protocol label switching (MPLS) network in which a traffic transfer is conducted through a preset label switching path (LSP), the apparatus comprising:
an LSP monitoring section which receives a performance measurement value of an LSP from a respective MPLS edge switch (MES), compares the performance measurement value with a certain threshold to output an analysis value, and calls for protection of the LSP when the outputted analysis value satisfies a certain condition; and
an LSP computation section which, when a request for the protection of the LSP is received from the LSP monitoring section, determines whether a substitute LSP for replacing the LSP exists, and wherein, when the substitute LSP exists, the LSP is replaced by the substitute LSP, and wherein, when the substitute LSP does not exist, a substitute LSP is set, and the LSP is replaced by the substitute LSP.

2. The apparatus according to claim 1, wherein when the analysis value for the LSP is lower than a required performance value at least a certain number of times, the LSP monitoring section calls for one of a protection and a replacement of the LSP.

3. The apparatus according to claim 1, wherein when the original LSP is replaced but then satisfies a certain condition, the LSP monitoring section calls for a restoration of the original LSP in place of the substitute LSP.

4. The apparatus according to claim 3, wherein when the analysis value for the LSP is higher than a required performance value at least a certain number of times, the LSP monitoring section calls for the restoration of the LSP.

5. The apparatus according to claim 1, wherein the LSP monitoring section uses at least one certain threshold for outputting the analysis value.

6. The apparatus according to claim 1, wherein a characteristic for the performance measurement includes at least one of transfer delay, jitter and transfer packet loss.

7. The apparatus according to claim 6, wherein the performance measurement of the characteristic is conducted by use of an operation, administration & maintenance (OAM) packet.

8. The apparatus according to claim 1, wherein the LSP monitoring section sets first and second thresholds, an analysis value of the first threshold being more excellent than an analysis value of the second threshold;
wherein, when all performance characteristics have performance more excellent than the first threshold, the LSP monitoring section determines the analysis value to be performance_OK;
wherein, when at least one characteristic has performance worse than the second threshold, the LSP monitoring section determines the analysis value to be performance_severely_worse;
wherein, when there is no characteristic having performance worse than the second threshold, but there is a characteristic having performance worse than the first threshold, the LSP monitoring section determines the analysis value to be performance_worse; and
wherein, when the value of performance_severely_worse is determined consecutively at least a certain number of times, the LSP monitoring section calls for one of protection and replacing the LSP.

9. The apparatus according to claim 8, wherein when the analysis value of a replaced LSP indicates performance_OK consecutively at least a certain number of times, the LSP monitoring section calls for a restoration of the replaced LSP.

10. An apparatus for performance management of an MPLS network in which an LSP is set and managed through a centralized control method, the apparatus comprising:
an LSP monitoring section which receives a performance measurement value of an LSP from a respective MPLS edge switch (MES), compares the performance measurement value with a certain threshold to output an analysis value, and calls for protection of the LSP when the outputted analysis value satisfies a certain condition; and
an LSP computation section which, when a request for the protection of the LSP is a received from the LSP monitoring section, determines whether a substitute LSP for replacing the LSP exists, and wherein, when the substitute LSP exists, the LSP is replaced by the substitute LSP, and wherein, when the substitute LSP does not exist, a substitute LSP is set, and the LSP is replaced by the substitute LSP.

11. A multi protocol label switching (MPLS) network, comprising:
an MPLS edge switch (MES) for measuring a performance value of a label switching path (LSP); and
an apparatus for performance management which receives the performance value from the MES, compares the performance value with a certain threshold to output an analysis value, and calls for protection of the LSP when the outputted value satisfies a certain condition.

12. The MPLS network according to claim 11, wherein the MES measures the performance value of the LSP by use of an operation, administration & maintenance (OAM) packet.

13. A multi protocol label switching (MPLS) network, comprising:
an MPLS edge switch (MES) which measures a performance value of a label switching path (LSP) and compares the measured performance value with a certain threshold to output an analysis value; and
an apparatus for performance management which receives the analysis value from the MES, and calls for a protection of the LSP when the received analysis value satisfies a certain condition.

14. The MPLS network according to claim 13, wherein the MES measures the performance value of the LSP by use of an operation, administration & maintenance (OAM) packet.

15. A method for performance management of a multi protocol label switching (MPLS) network in which traffic transfer is conducted through a preset label switching path (LSP), the method comprising the steps of:
(a) measuring a performance value of the LSP;
(b) deriving an analysis value by comparing the measured value of the LSP to a certain threshold;
(c) determining whether the analysis value satisfies a certain condition; and
(d) determining that protection of the LSP is appropriate when the analysis value satisfies the certain condition.

16. The method according to claim 15, wherein a characteristic for LSP performance measurement includes at least one of transfer delay, jitter and transfer packet loss.

17. The method according to claim 15, wherein in step (c), when the analysis value for the LSP is lower than a required performance value consecutively for at least a certain number of times, it is determined that the analysis value satisfies the certain condition.

18. The method according to claim 15, further comprising step (e) of restoring the LSP when the analysis value of a replaced LSP is higher than a required performance value consecutively for at least a certain number of times.

19. The method according to claim 15, wherein step (d) further comprises setting a substitute LSP for replacing the LSP when a substitute LSP for replacing the LSP does not exist.
